(19) United States
(12) Patent Application Publication
(10) Pub. No.: US 2018/0307440 A1
(43) Pub. Date: Oct. 25, 2018

(54) STORAGE CONTROL APPARATUS AND STORAGE CONTROL METHOD

(71) Applicant: FUJITSU LIMITED, Kawasaki-shi (JP)

(72) Inventors: Naohiro Takeda, Zushi (JP); Norihide KUBOTA, Kawasaki (JP); YOSHIHITO KONTA, Kawasaki (JP); Yusuke Kurasawa, Nagano (JP); Toshio Kikuchi, Sagamihara (JP); Yuji TANAKA, Inagi (JP); Marino Kajiyama, Yokohama (JP); Yusuke Suzuki, Kawasaki (JP); YOSHINARI SHINOZAKI, Kawasaki (JP); Takeshi WATANABE, Kawasaki (JP)

(73) Assignee: FUJITSU LIMITED, Kawasaki-shi (JP)

(21) Appl. No.: 15/949,134

(22) Filed: Apr. 10, 2018

(30) Foreign Application Priority Data
Apr. 20, 2017 (JP) 2017-083857

(51) Int. Cl. G06F 3/06; G06F 12/10

(52) U.S. Cl. CPC G06F 3/0659; G06F 3/0616; G06F 3/0647; G06F 3/0679; G06F 2212/657; G06F 3/0688; G06F 2212/1036; G06F 2212/202; G06F 12/10

(57) ABSTRACT

A storage control apparatus configured to control a storage device including a storage medium having a limit of a number of writes, includes a memory, and a processor coupled to the memory and configured to store, in the memory, address conversion information in which a logical address used to identify data by an information processing device using the storage device and a physical address indicating a memory location of the data in the storage medium are associated with each other, and execute a bulk writing of a piece of the address conversion information into the storage medium sequentially.

### CROSS-REFERENCE TO RELATED APPLICATION

This application is based upon and claims the benefit of priority of the prior Japanese Patent Application No. 2017-83857, filed on Apr. 20, 2017, the entire contents of which are incorporated herein by reference.

### FIELD

The embodiments discussed herein are related to a storage control apparatus and a storage control method.

### BACKGROUND

Recently, the mainstay of a storage medium of a storage device has been shifting from a hard disk drive (HDD) to a flash memory such as a solid state drive (SSD) having higher access speed. In the SSD, data is not allowed to be directly overwritten into a memory cell, and for example, data is written after data has been deleted in a one-megabyte (MB) unit block.

Therefore, in update of some pieces of data in the block, after the other pieces of data in the block has been evacuated, and the block has been deleted, the evacuated data and the updated data are written into the SSD. Accordingly, processing is slow in which data with a size smaller than the size of the block is updated. In addition, the number of writes into the SSD is limited. Therefore, it is desirable that, in the SSD, update of the data with a size smaller than the size of the block is avoided. Thus, when some pieces of data in the block are to be updated, the other pieces of data in the block and the pieces of data to be updated are written in a new block.

However, when data is updated by using a new block, a physical address at which the data is stored is changed, and therefore, it is desirable that management data (meta data) in which a logical address and a physical address of the data are associated with each other is updated. In addition, in the storage device, a duplicated data block is deleted in order to reduce the write capacity of data, and it is desirable that management data for deduplication is also updated.

In a log structured file system, there is a technology in which a storage device includes a first area and a second area, and the first area and the second area are used as follows. In the second area, a large amount of data and a large number of nodes for the large amount of data are stored. In the first area, a node address table is stored that includes a large number of node identifiers corresponding to the respective nodes and a large number of physical addresses corresponding to the respective node identifiers. In such a technology, an additional write operation for meta-data modification may be reduced.

In addition, there is a technology in which, in a case of a random write access, data recorded in a page of a block selected in accordance with an unused page is written into a buffer, and the data written into the buffer after deletion of the block is written into a block. In such a technology, garbage collection is not performed, and therefore, input output per second (IOPS) performance may be improved.

In addition, there is a technology in which, in a disk storage device constituted by N disk devices, a logical block of data to be updated is accumulated in a write buffer having a capacity corresponding to N×K logical blocks, and a control device performs the following control. That is, the control device delays update of the logical blocks until the number of accumulated logical blocks reaches N×K−1, and writes N×K logical blocks obtained by adding a logical address tag block of the logical blocks to the N×K−1 logical blocks into an empty area continuously and sequentially when the number of logical blocks reaches N×K−1. Such a technology may construct an inexpensive high-speed disk storage device by making a map of the logical address and the physical address unnecessary in principle.

Japanese Laid-open Patent Publication No. 2014-71906, Japanese Laid-open Patent Publication No. 2010-237907, and Japanese Laid-open Patent Publication No. 11-53235 are related arts.

### SUMMARY

According to an aspect of the invention, a storage control apparatus configured to control a storage device including a storage medium having a limit of a number of writes, includes a memory, and a processor coupled to the memory and configured to store, in the memory, address conversion information in which a logical address used to identify data by an information processing device using the storage device and a physical address indicating a memory location of the data in the storage medium are associated with each other, and execute a bulk writing of a piece of the address conversion information into the storage medium sequentially.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a storage configuration of a storage device according to an embodiment;

FIG. 2 is a diagram illustrating a format of a RAID unit;

FIGS. 3A to 3C are diagrams illustrating a format of reference meta;

FIG. 4 is a diagram illustrating a format of logical/physical meta;

FIGS. 5A to 5D are diagrams illustrating a meta-meta scheme according to the embodiment;

FIG. 6 is a diagram illustrating a format of a meta address;

FIG. 7 is a diagram illustrating an arrangement example of RAID units in a drive group;

FIG. 8 is a diagram illustrating a configuration of an information processing system according to the embodiment;

FIG. 9 is a diagram illustrating a relationship between function units;

FIG. 10A is a diagram illustrating a sequence of write processing of data the duplication of which does not exist;

FIG. 10B is a diagram illustrating a sequence of write processing of data the duplication of which exists;

FIG. 11 is a diagram illustrating a sequence of read processing;

FIG. 12A is a diagram illustrating the number of small writes before introduction of the meta-meta scheme;

FIG. 12B is a diagram illustrating the number of small writes in the meta-meta scheme;

FIG. 12C is diagram illustrating the number of small writes in the meta-meta scheme without invalidation of old data; and

FIG. 13 is a diagram illustrating a hardware configuration of a storage control apparatus that executes a storage control program according to the embodiment.

### DESCRIPTION OF EMBODIMENTS

When management data in which a logical address and a physical address are associated with each other, management data used for deduplication, or the like is updated, some pieces of data in a block are updated, and therefore, it is desirable that the management data is arranged in a main memory. However, as the size of management data becomes large, it is difficult to hold all pieces of management data in the main memory. Therefore, the pieces of management data are written into an SSD, but a problem occurs in which the number of writes into the SSD increases due to update of management data.

In an aspect of the embodiment, an object is to reduce the number of writes into an SSD due to update of management data.

Embodiments of a storage control apparatus, a storage control method, and a storage control program of the technology discussed herein are described below in detail with reference to the drawings. Such embodiments do not limit the technology discussed herein.

### EMBODIMENT

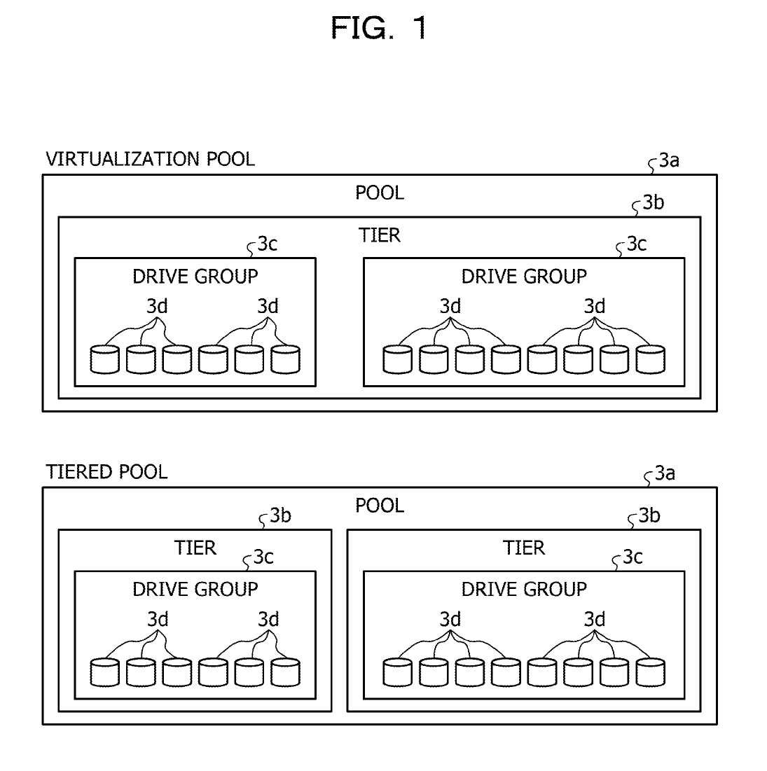

First, a data management method of a storage device according to an embodiment is described with reference to FIGS. 1 to 7. FIG. 1 is a diagram illustrating a storage configuration of the storage device according to the embodiment. As illustrated in FIG. 1, the storage device according to the embodiment manages two or more SSDs 3d as a pool 3a based on redundant arrays of inexpensive disks (RAID) 6. In addition, the storage device according to the embodiment includes two or more pools 3a.

Examples of the pool 3a include a virtualization pool and a tiered pool. The virtualization pool includes a single tier 3b and the tiered pool includes two or more tiers 3b. The tier 3b includes one or more drive groups 3c. The drive group 3c is a group of SSDs 3d, the number of which is 6 to 24. For example, from among six SSDs 3d each of which stores a single stripe, three SSDs are used for data storage, two SSDs are used for parity storage, and the other SSD is used for hot spare. The drive group 3c may include 25 or more SSDs 3d.

The storage device according to the embodiment manages data on a RAID unit basis. Physical allocation of thin provisioning is typically performed on a chunk unit basis, which has a fixed size, and one chunk corresponds to one RAID unit. In the following description, the chunk is referred to as a RAID unit. The RAID unit is a continuous physical area having 24 MB allocated from the pool 3a. The storage device according to the embodiment buffers data in the main memory on a RAID unit basis and writes the data into SSD 3d sequentially.

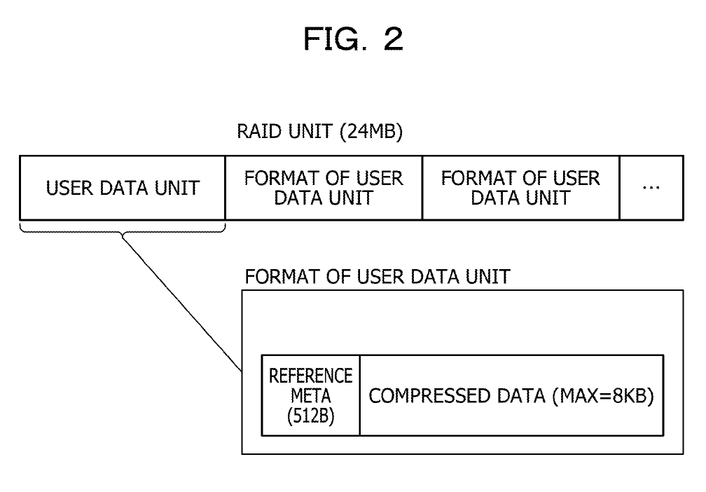

FIG. 2 is a diagram illustrating a format of a RAID unit. As illustrated in FIG. 2, the RAID unit includes two or more user data units (also referred to as data logs). The user data unit includes reference meta and compressed data. The reference meta is management data of data to be written into the SSD 3d.

The compressed data is compressed data to be written into the SSD 3d. The size of the data is 8 kilobytes (KB) at the most. In a case in which the compression ratio is 50%, for example, when “24 MB/4.5 KB≃5461” user data units are stored in a single RAID unit, the storage device according to the embodiment writes the RAID unit into the SSD3d.

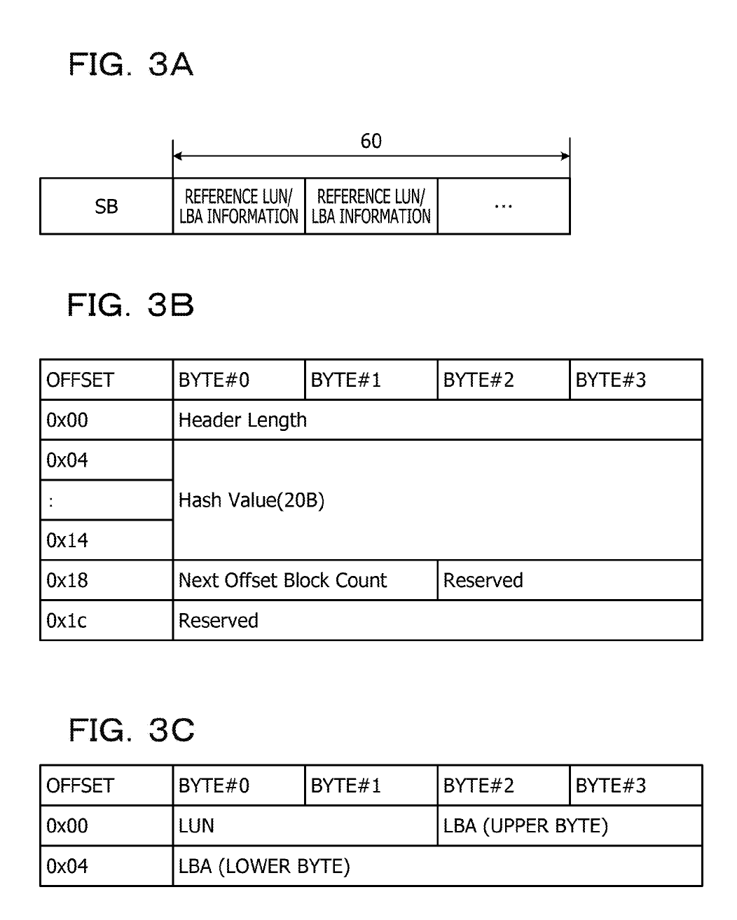

FIGS. 3A to 3C are diagrams illustrating a format of reference meta. As illustrated in FIG. 3A, in the reference meta, an area having a storage capacity is secured into which a super block (SB) and 60 pieces of reference logical unit number (LUN)/logical block address (LBA) information of reference destinations are allowed to be written at the most. The size of the SB is 32 bytes (B), and the size of the reference meta is 512B. The size of each of the pieces of reference LUN/LBA information is 8B. When a new reference destination is created due to deduplication, the reference meta is updated by adding the reference destination to the reference meta. However, even when a reference destination disappears due to update of data, reference LUN/LBA information is not deleted and is maintained. Invalid reference LUN/LBA information is collected by garbage collection.

As illustrated in FIG. 3B, the SB includes “Header Length” of 4B, “Hash Value” of 20B, and “Next Offset Block Count” of 2B. Here, “Header Length” is a length of the reference meta. In addition, “Hash Value” is a hush value of the data and is used for deduplication. In addition, “Next Offset Block Count” is a location of reference LUN/LBA information to be stored next. “Reserved” is for expansion in the future.

As illustrated in FIG. 3C, the reference LUN/LBA information includes “LUN” of 2B and “LBA” of 6B.

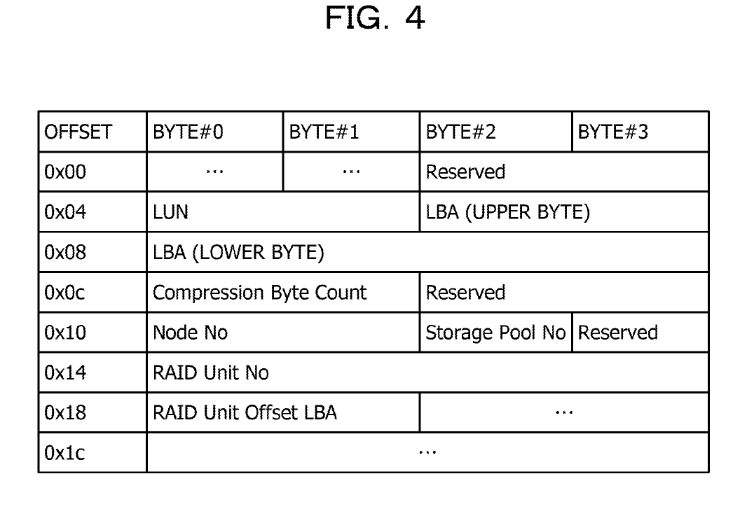

In addition, the storage device according to the embodiment manages a correspondence relationship of a logical address and a physical address of data by using logical/physical meta that is logical/physical conversion information. FIG. 4 is a diagram illustrating a format of logical/physical meta. The storage device according to the embodiment manages the information illustrated in FIG. 4 for each 8 KB piece data.

As illustrated in FIG. 4, the size of the logical/physical meta is 32B. The logical/physical meta includes the LUN of 2B and the LBA of 6B as a logical address of the data. In addition, the logical/physical meta also includes “Compression Byte Count” of 2B as the number of bytes of the compressed data.

In addition, the logical/physical meta also includes “Node No” of 2B, “Storage Pool No” of 1B, “RAID Unit No” of 4B, and “RAID Unit Offset LBA” of 2B as a physical address.

Here, “Node No” is a number used to identify a storage control apparatus responsible for a pool 3a to which a RAID unit that stores a user data unit belongs. The storage control apparatus is described later. In addition, “Storage Pool No” is a number used to identify the pool 3a to which the RAID unit that stores the user data unit belongs. In addition, “RAID Unit No” is a number used to identify the RAID unit that stores the user data unit. In addition, “RAID Unit Offset LBA” is an address of the user data unit in the RAID unit.

The storage device according to the embodiment manages pieces of logical/physical meta on a RAID unit basis. When the storage device according to the embodiment buffers pieces of logical/physical meta in the main memory on a RAID unit basis, and the storage device writes pieces of logical/physical meta into the SSD 3d sequentially in bulk, for example, when 786432 entries are stored in the buffer. Therefore, the storage device according to the embodiment manages pieces of information each indicating a location at which logical/physical meta exists by the meta-meta scheme.

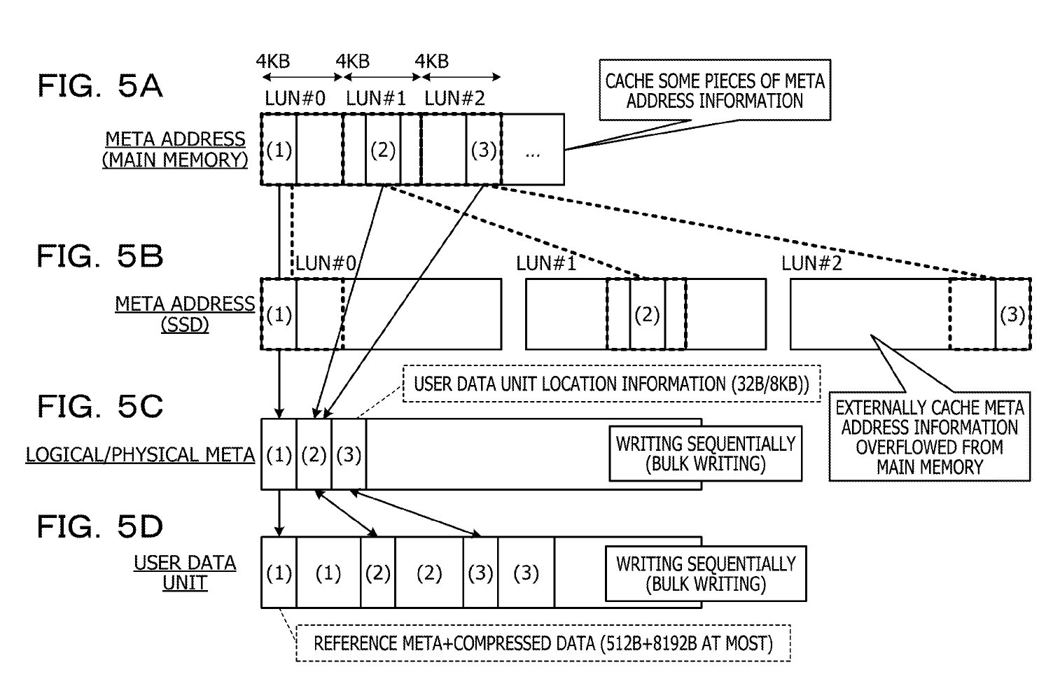

FIGS. 5A to 5D are diagrams illustrating the meta-meta scheme according to the embodiment. As illustrated in FIG. 5D, user data units indicated by respective (1), (2), (3), . . . are written into the SSD 3d on a RAID unit basis in bulk. In addition, as illustrated in FIG. 5C, pieces of logical/physical meta respectively indicating locations of the user data units are also written into the SSD 3d on a RAID unit basis in bulk.

In addition, as illustrated in FIG. 5A, the storage device according to the embodiment manages the location of logical/physical meta in the main memory by using a meta address for each LUN/LBA. However, as illustrated in FIG. 5B, meta address information that has been overflowed from the main memory is externally cached (secondarily cached). Here, the external cache is cache in the SSD 3d.

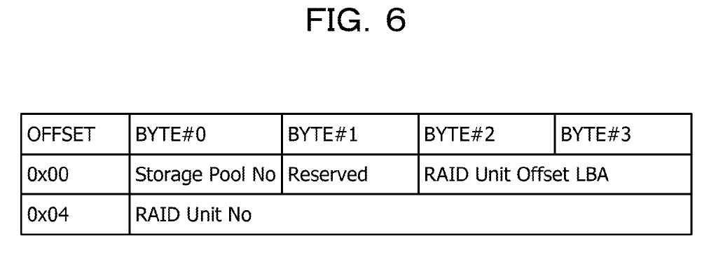

FIG. 6 is a diagram illustrating a format of a meta address. As illustrated in FIG. 6, the size of the meta address is 8B. The meta address includes “Storage Pool No”, “RAID Unit Offset LBA”, and “RAID Unit No”. The meta address is a physical address indicating the storage location of logical/physical data in the SSD 3d.

Here, “Storage Pool No” is a number used to identify a pool 3a to which a RAID unit that stores logical/physical meta belongs. “RAID Unit Offset LBA” is an address of the logical/physical meta in the RAID unit. “RAID Unit No” is a number used to identify the RAID unit that stores the logical/physical meta.

512 meta addresses are managed as a meta address page (4 KB) and meta addresses are cached in the main memory in a unit of a meta address page. In addition, the meta address information is stored, for example, from the beginning of the SSD 3d on a RAID unit basis.

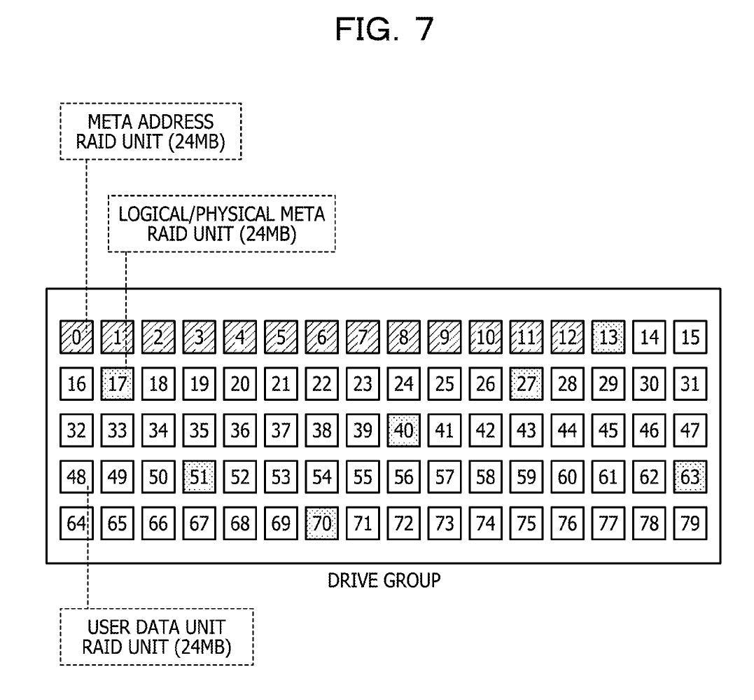

FIG. 7 is a diagram illustrating an arrangement example of RAID units in the drive group 3c. As illustrated in FIG. 7, a RAID unit that stores a meta address is arranged at the beginning of the drive group. In FIG. 7, RAID units the numbers of which are “0” to “12” correspond to RAID units each of which stores a meta address. When a meta address is updated, the RAID unit that stores the meta address is overwritten and saved.

When a corresponding buffer is filled with RAID units each of which stores logical/physical meta or RAID units each of which stores a user data unit, the RAIDs are written out to the drive group in order. In FIG. 7, in the drive group, RAID units the numbers of which are “13”, “17”, “27”, “40”, “51”, “63”, and “70” correspond to RAID units each of which stores logical/physical meta, and the other RAID units correspond to RAID units each of which stores a user data unit.

The storage device according to the embodiment holds minimum information in the main memory by the meta-meta scheme, and pieces of logical/physical meta and user data units are written into the SSD 3d in bulk sequentially, such that the number of writes into the SSD 3d may be reduced.

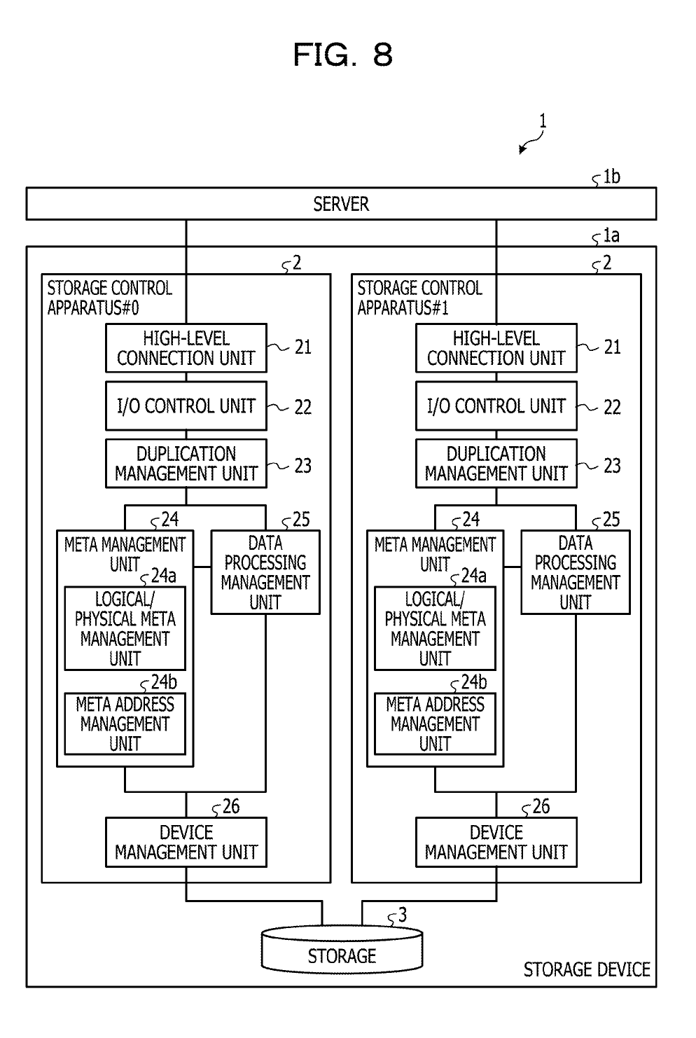

A configuration of an information processing system according to the embodiment is described below. FIG. 8 is a diagram illustrating the configuration of the information processing system according to the embodiment. As illustrated in FIG. 8, an information processing system 1 according to the embodiment includes a storage device 1a and a server 1b. The storage device 1a is a device that stores pieces of data used by the server 1b. The server 1b is an information processing device that performs an operation such as information processing. The storage device 1a and the server 1b are coupled to each other through a fiber channel (FC) and an internet small computer system interface (iSCSI).

The storage device 1a includes storage control apparatuses 2 that control the storage device 1a and a storage (memory device) 3 that stores pieces of data. Here, the storage 3 is constituted by two or more memory devices (SSDs) 3d.

In FIG. 8, the storage device 1a includes two storage control apparatuses 2 respectively referred to as a storage control apparatus #0 and a storage control apparatus #1, but may include three or more storage control apparatuses 2. In addition, in FIG. 8, the information processing system 1 includes a single server 1b, but may include two or more servers 1b.

The storage control apparatuses 2 shares management of the storage 3 and each of the storage control apparatuses 2 is responsible for one or more the pools 3a. The storage control apparatus 2 includes a high-level connection unit 21, an I/O control unit 22, a duplication management unit 23, a meta management unit 24, a data processing management unit 25, and a device management unit 26.

The high-level connection unit 21 transmits and receives pieces of information between the I/O control unit 22, and an FC driver and an iSCSI driver. The I/O control unit 22 manages pieces of data on the cache memory. The duplication management unit 23 manages pieces of unique data stored in the storage device 1a by controlling data deduplication/restoration.

The meta management unit 24 manages meta addresses and pieces of logical/physical meta. In addition, the meta management unit 24 executes conversion processing between a logical address used to identify data in a virtual volume and a physical address indicating a location at which the data is stored in the SSD 3d by using a meta address and logical/physical meta.

The meta management unit 24 includes a logical/physical meta management unit 24a and a meta address management unit 24b. The logical/physical meta management unit 24a manages pieces of logical/physical meta related to pieces of address conversion information in each of which a logical address and a physical address are associated with each other. The logical/physical meta management unit 24a requests the data processing management unit 25 to write logical/physical meta into the SSD 3d and read logical/physical meta from the SSD 3d. The logical/physical meta management unit 24a specifies a memory location of the logical/physical meta by using a meta address.

The meta address management unit 24b manages meta addresses. The meta address management unit 24b requests the device management unit 26 to write a meta address into the external cache (secondary cache) and read a meta address from the external cache.

The data processing management unit 25 manages pieces of user data by consecutive user data units and writes pieces of user data into the SSD 3d in bulk sequentially on a RAID unit basis. In addition, the data processing management unit 25 compresses and decompresses data and generates reference meta. However, the data processing management unit 25 does not update reference meta included in a user data unit corresponding to old data when data is updated.

In addition, the data processing management unit 25 writes pieces of logical/physical meta into the SSD 3d in bulk sequentially on a RAID unit basis. In the writing of the pieces of logical/physical meta, 16 entries of pieces of logical/physical meta are written into one small block (512B) sequentially, such that the data processing management unit 25 manages pieces of logical/physical meta such that two identical LUNs or two identical LBAs are not included in the same small block.

The data processing management unit 25 may search for an LUN and an LBA by a RAID unit number and an LBA in the RAID unit by managing piece of logical/physical meta such that two identical LUNs or two identical LBAs are not included in the same small block. In order to distinguish a block of 1 MB that is a deletion unit of data from a block of 512B, the block of 512B is referred to as a small block.

In addition, when the meta management unit 24 requests reading of logical/physical meta, the data processing management unit 25 searches a small block that has been specified by the meta management unit 24 for a target LUN and a target LBA and sends the target LUN and the target LBA to the data processing management unit 25.

The data processing management unit 25 stores pieces of write data in a write buffer that is a buffer in the main memory and writes the pieces of data out to the SSD 3d when the pieces of data exceed a specific threshold value. The data processing management unit 25 manages a physical space of a pool 3a and arranges RAID units. The device management unit 26 writes a RAID unit into the storage 3.

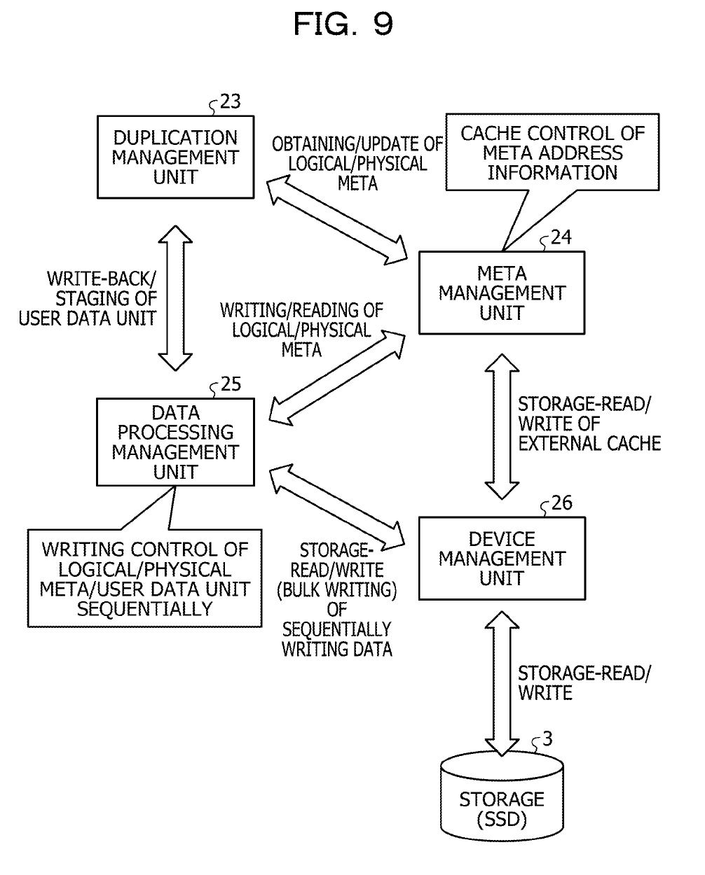

FIG. 9 is a diagram illustrating a relationship between the function units. As illustrated in FIG. 9, between the duplication management unit 23 and the meta management unit 24, obtaining and update of logical/physical meta are performed. Between the duplication management unit 23 and the data processing management unit 25, write-back and staging of a user data unit are performed. Here, the write-back is writing data into the storage 3, and the staging is reading of data from the storage 3.

Between the meta management unit 24 and the data processing management unit 25, writing and reading of logical/physical meta are performed. Between the data processing management unit 25 and the device management unit 26, storage-read and storage-write of write-once data are performed. Between the meta management unit 24 and the device management unit 26, storage-read and storage-write of the external cache are performed. Between the device management unit 26 and the storage 3, storage-read and storage-write are performed.

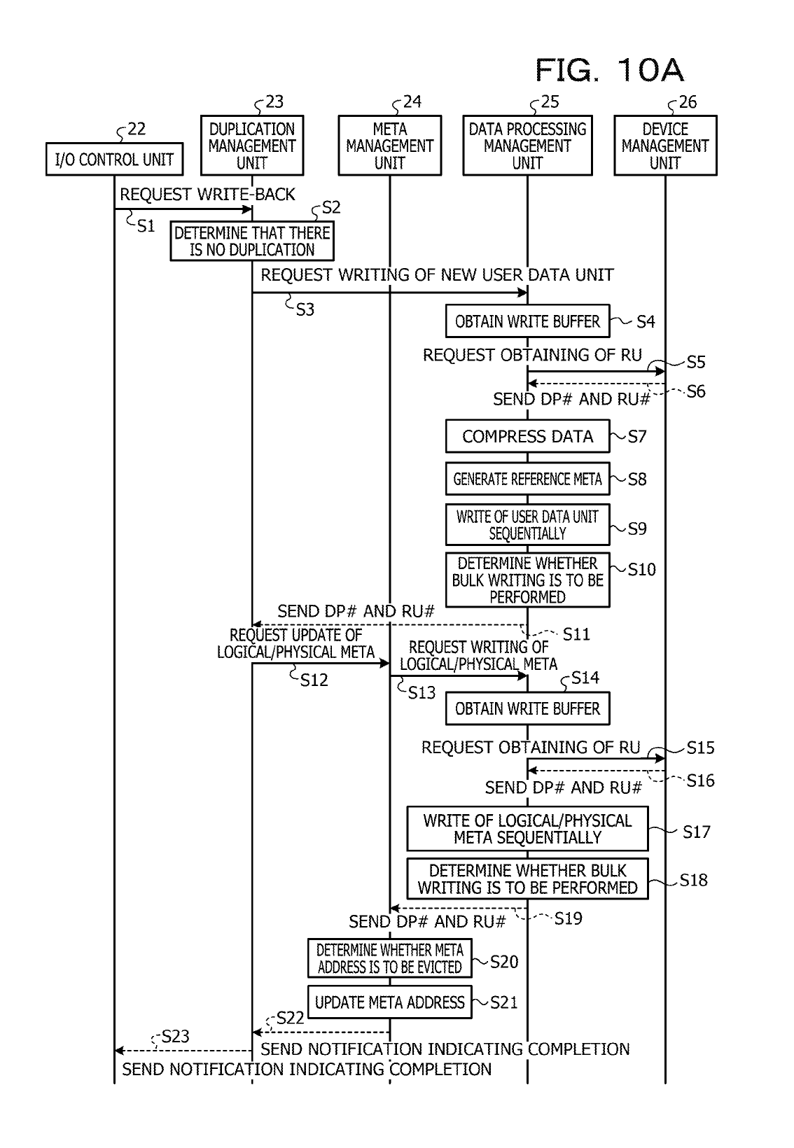

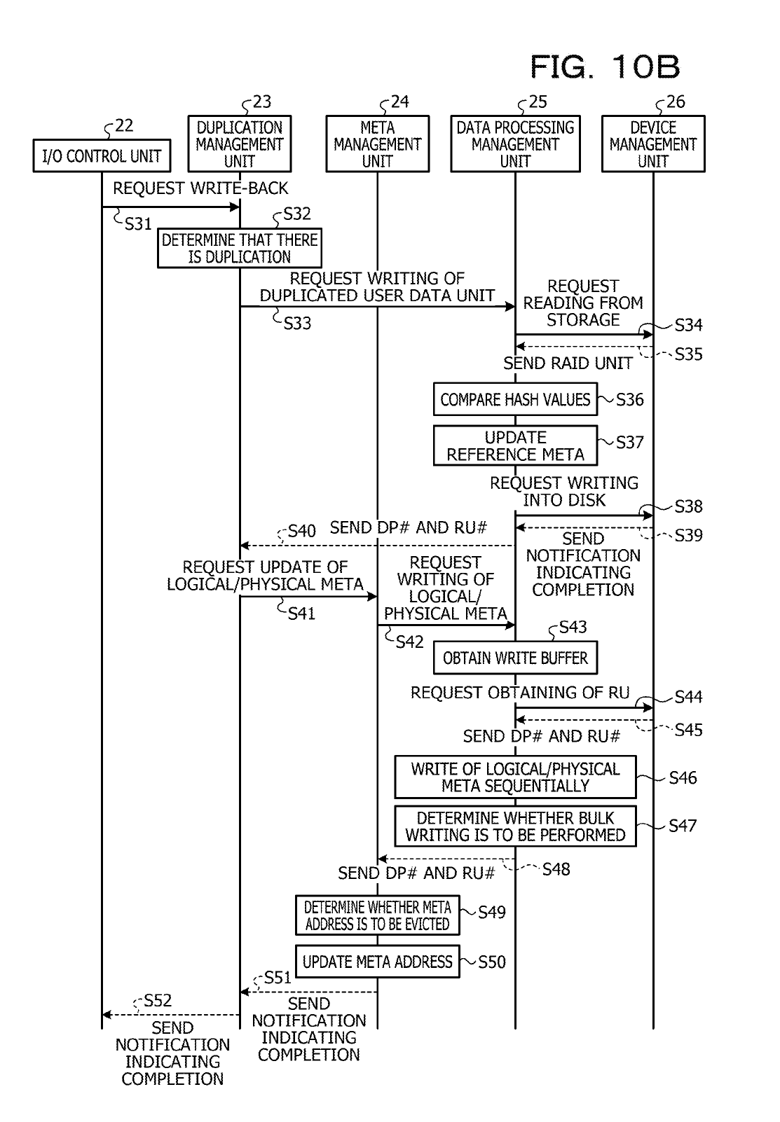

A sequence of write processing is described below. FIG. 10A is a diagram illustrating a sequence of write processing of data the duplication of which does not exist, and FIG. 10B is a diagram illustrating a sequence of write processing of data the duplication of which exists.

In the write processing of data the duplication of which does not exist, as illustrated in FIG. 10A, the I/O control unit 22 requests the duplication management unit 23 to perform write-back of data (Step S1). Therefore, the duplication management unit 23 determines that there is no duplication of data (Step S2), the duplication management unit 23 requests the data processing management unit 25 to write a new user data unit (Step S3).

Therefore, the data processing management unit 25 obtains a write buffer (Step S4), and requests the device management unit 26 to obtain an RU (RAID unit) (Step S5). When the data processing management unit 25 has already obtained the write buffer, it does not seek to obtain a new write buffer by the data processing management unit 25. In addition, the data processing management unit 25 obtains a DP# (Storage Pool No) and a RU# (RAID Unit No) from the device management unit 26 (Step S6).

In addition, the data processing management unit 25 compresses data (Step S7) and generates reference meta (Step S8). In addition, the data processing management unit 25 writes a user data unit in the write buffer sequentially (Step S9) and determines whether bulk writing of the write buffer is to be performed (Step S10). In addition, the data processing management unit 25 determines that bulk writing of the write buffer is to be performed, the data processing management unit 25 requests the device management unit 26 to perform bulk writing of the write buffer. In addition, the data processing management unit 25 sends the DP# and the RU# to the duplication management unit 23 (Step S11).

Therefore, the duplication management unit 23 requests the meta management unit 24 to update logical/physical meta (Step S12), and the meta management unit 24 requests the data processing management unit 25 to write the updated logical/physical meta (Step S13).

Therefore, the data processing management unit 25 obtains a write buffer (Step S14), and requests the device management unit 26 to obtain an RU (Step S15). The obtained write buffer is a buffer different from the write buffer for a user data unit. In addition, when the data processing management unit 25 has already obtained the write buffer, it does not seek to obtain a new write buffer by the data processing management unit 25. In addition, the data processing management unit 25 obtains a DP# and an RU# from the device management unit 26 (Step S16).

In addition, the data processing management unit 25 writes logical/physical meta in the write buffer sequentially (Step S17), and determines whether bulk writing of the write buffer is to be performed (Step S18). In addition, the data processing management unit 25 determines that bulk writing of the write buffer is to be performed, the data processing management unit 25 requests the device management unit 26 to perform bulk writing of the write buffer. In addition, the data processing management unit 25 sends the DP# and the RU# to the meta management unit 24 (Step S19).

Therefore, the meta management unit 24 determines whether a meta address is to be evicted for address update (Step S20), and when the meta management unit 24 determines that a meta address is to be evicted, the meta management unit 24 requests the device management unit 26 to evict the meta address. In addition, the meta management unit 24 updates the meta address in accordance with the DP# and the RU# (Step S21).

In addition, the meta management unit 24 notifies the duplication management unit 23 of completion the update (Step S22), and when the duplication management unit 23 receives the notification of the completion from the meta management unit 24, the duplication management unit 23 notifies the I/O control unit 22 of the notification of the update (Step S23).

As described above, the number of writes into the SSD 3d may be reduced when the data processing management unit 25 writes pieces of logical/physical meta sequentially in bulk, in addition to user data units.

In addition, in writing of data the duplication of which exists, as illustrated in FIG. 10B, the I/O control unit 22 requests the duplication management unit 23 to perform write-back of data (Step S31). Therefore, the duplication management unit 23 determines that there is a duplication of the data (Step S32), such that the duplication management unit 23 requests the data processing management unit 25 to write the duplicated user data unit (Step S33).

Therefore, the data processing management unit 25 requests the device management unit 26 to read a RAID unit including the duplicated user data unit from the storage 3 (Step S34). In addition, the device management unit 26 reads the RAID unit including the duplicated user data unit and sends the read RAID unit to the data processing management unit 25 (Step S35). In addition, the data processing management unit 25 compares hush values (Step S36) to determine whether data has been duplicated.

In addition, the data processing management unit 25 updates reference meta in the duplicated user data unit by adding a reference destination to the reference meta when the duplication exists (Step S37). The data processing management unit 25 requests the device management unit 26 to write a RAID unit of the user data unit in which the reference meta has been updated, into the storage 3 (Step S38) and receives a response from the device management unit 26 (Step S39). In addition, the data processing management unit 25 sends a DP# and an RU# to the duplication management unit 23 (Step S40).

Therefore, the duplication management unit 23 requests the meta management unit 24 to update logical/physical meta (Step S41), and the meta management unit 24 requests the data processing management unit 25 to write the updated logical/physical meta (Step S42).

Therefore, the data processing management unit 25 obtains a write buffer (Step S43) and requests the device management unit 26 to obtain an RU (Step S44). In addition, the data processing management unit 25 obtains a DP# and an RU# from the device management unit 26 (Step S45).

In addition, the data processing management unit 25 writes the logical/physical meta in the write buffer sequentially (Step S46) and determines whether bulk writing of the write buffer is to be performed (Step S47). In addition, when the data processing management unit 25 determines that bulk writing of the write buffer is to be performed, the data processing management unit 25 requests the device management unit 26 to perform bulk writing of the write buffer. In addition, the data processing management unit 25 sends the DP# and the RU# to the meta management unit 24 (Step S48).

Therefore, the meta management unit 24 determines whether a meta address is to be evicted for meta address update (Step S49), and when the meta management unit 24 determines that a meta address is to be evicted, the meta management unit 24 requests the device management unit 26 to evict the meta address. In addition, the meta management unit 24 updates the meta address in accordance with the DP# and the RU# (Step S50).

In addition, the meta management unit 24 notifies the duplication management unit 23 of completion of the update (Step S51), and when the duplication management unit 23 receives the notification from the meta management unit 24, the duplication management unit 23 notifies the I/O control unit 22 of the completion of the update (Step S52).

As described above, the data processing management unit 25 may reduce the number of writes into the SSD 3d by writing pieces of logical/physical meta sequentially in bulk, for duplicated data.

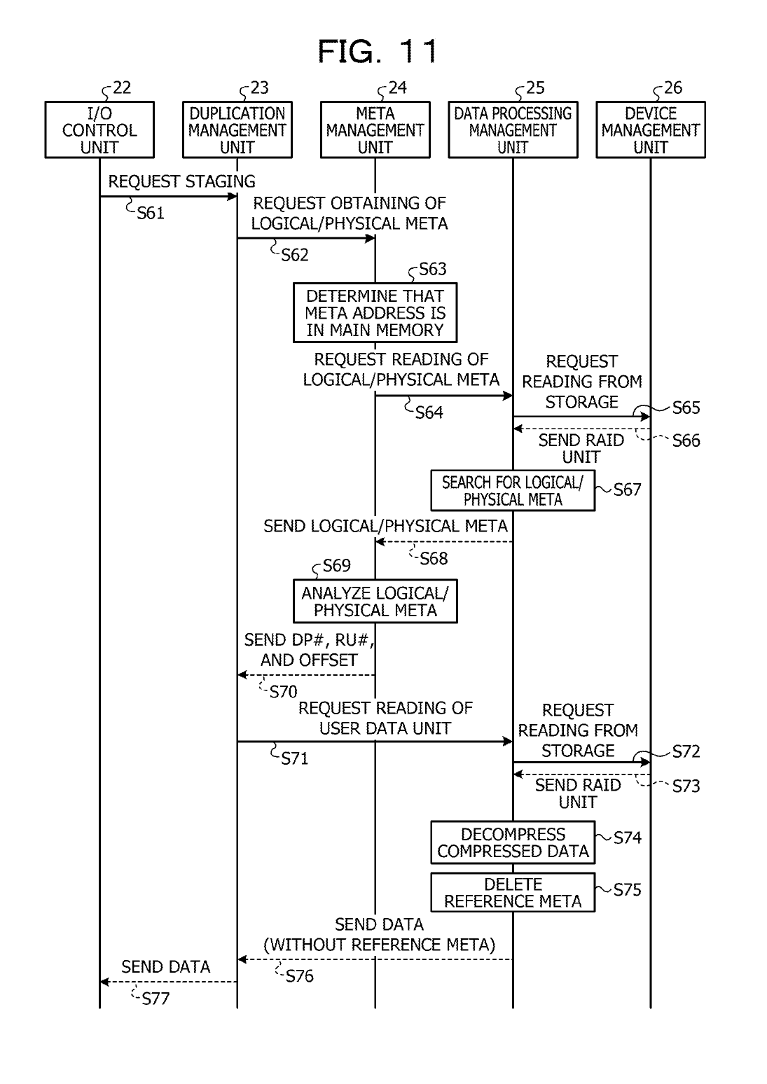

A sequence of read processing is described below. FIG. 11 is a diagram illustrating the sequence of the read processing. As illustrated in FIG. 11, the I/O control unit 22 requests the duplication management unit 23 to perform staging of data (Step S61). Therefore, the duplication management unit 23 requests the meta management unit 24 to obtain logical/physical meta of the data (Step S62).

Therefore, the meta management unit 24 determines whether a meta address of the data is in the main memory (Step S63) and requests the data processing management unit 25 to read logical/physical meta by specifying the meta address (Step S64). When the meta address of the data is not in the main memory, the meta management unit 24 requests the device management unit 26 to read logical/physical meta from the storage 3.

In addition, the data processing management unit 25 requests the device management unit 26 to read a RAID unit including the logical/physical meta from the storage 3 (Step S65) and receives the RAID unit from the device management unit 26 (Step S66). In addition, the data processing management unit 25 searches the RAID unit for the logical/physical meta (Step S67) and transmits the obtained logical/physical meta to the meta management unit 24 (Step S68).

Therefore, the meta management unit 24 analyzes the logical/physical meta (Step S69) and transmits a DP#, an RU#, and an Offset of the RAID unit including the user data unit to the duplication management unit 23 (Step S70). Here, the Offset is an address of the user data unit in the RAID unit. Therefore, the duplication management unit 23 requests the data processing management unit 25 to read the user data unit by specifying the DP#, the RU#, and the Offset (Step S71).

Therefore, the data processing management unit 25 requests the device management unit 26 to read the RAID unit including the user data unit from the storage 3 (Step S72) and receives the RAID unit from the device management unit 26 (Step S73). In addition, the data processing management unit 25 decompresses compressed data included in the user data unit that has been extracted from the RAID unit by using the Offset (Step S74) and deletes the reference meta from the user data unit (Step S75).

In addition, the data processing management unit 25 transmits the data to the duplication management unit 23 (Step S76) and the duplication management unit 23 transmits the data to the I/O control unit 22 (Step S77).

As described above, the storage control apparatus 2 may read the data from the storage 3 by obtaining logical/physical meta by using a meta address and obtaining a user data unit by using the logical/physical meta.

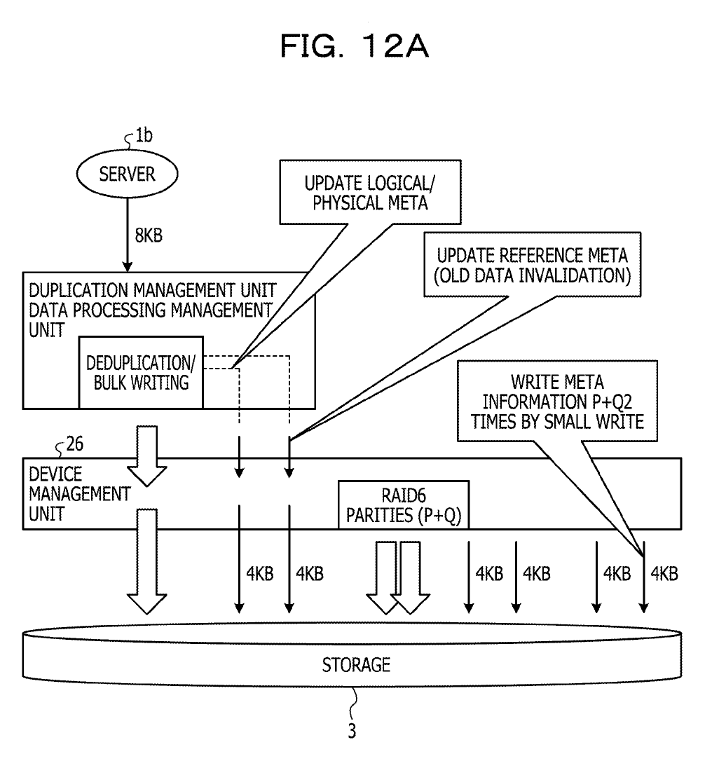

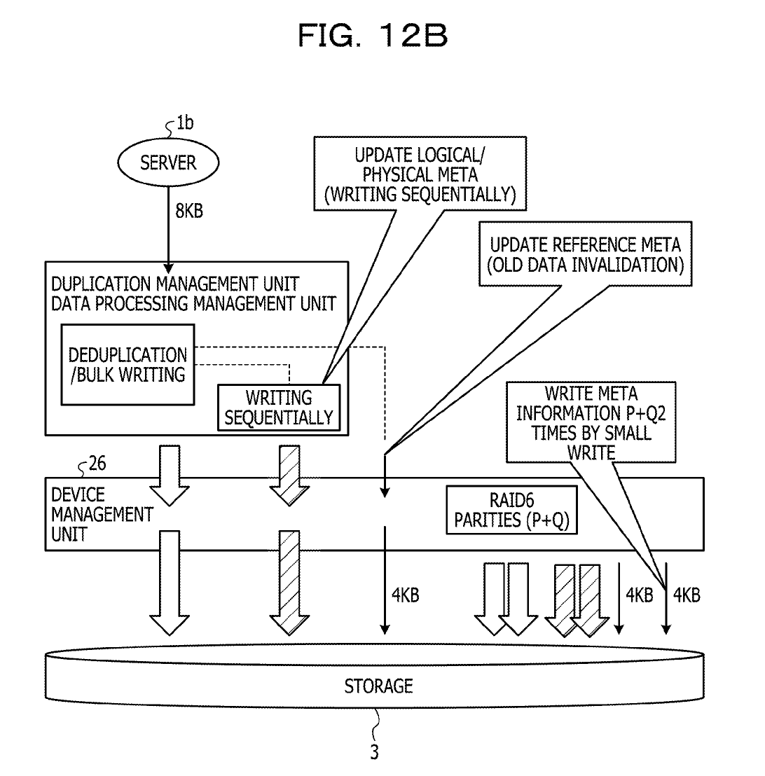

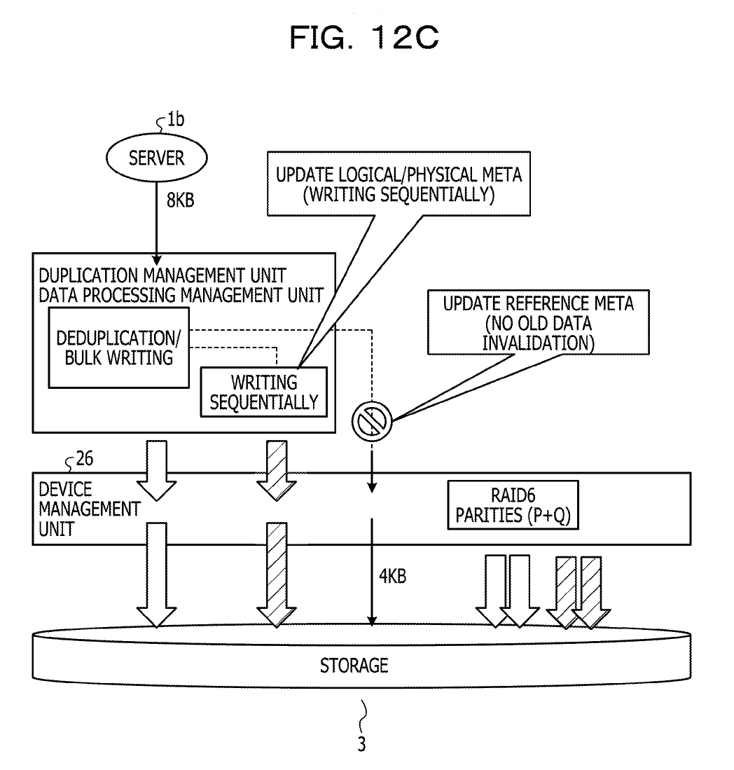

An effect of the write processing by the storage control apparatus 2 is described with reference to FIGS. 12A to 12C. FIG. 12A is a diagram illustrating the number of small writes before introduction of the meta-meta scheme, FIG. 12B is a diagram illustrating the number of small writes in the meta-meta scheme, and FIG. 12C is diagram illustrating the number of small writes in the meta-meta scheme without invalidation of old data. Here, the small writing is writing having a small unit (4 KB), compared with the block (1 MB).

As illustrated in FIG. 12A, before introduction of the meta-meta scheme, bulk writing is performed for data of 8 KB from the server 1b, and small writing is performed for update of logical/physical meta and update of reference meta. Here, examples of the update of reference meta include invalidation of old data (reference LUN/LBA information). In addition, in a case of the RAID 6, writing of two parities P and Q is performed correspondingly to writing of data. Thus, small writing is performed six times in total.

On the contrary, in the meta-meta scheme, as illustrated in FIG. 12B, update of logical/physical meta does not correspond to small writing sequentially, such that the small writing is performed only three times. In addition, when old data invalidation is not performed, as illustrated in FIG. 12C, update of reference meta also does not correspond to small writing, such that small writing is not performed in this case.

As described above, when the meta-meta scheme is used, the storage control apparatus 2 may reduce the number of small writes and increase speed of the write processing. In addition, the storage control apparatus 2 may further reduce the number of small writes without old data invalidation.

As described above, in the embodiment, the logical/physical meta management unit 24a manages pieces of information on logical/physical meta in each of which a logical address and a physical address of data are associated with each other, and the data processing management unit 25 writes the pieces of information on logical/physical meta into the SSD 3d sequentially in bulk on a RAID unit basis. Thus, the storage control apparatus 2 reduces the number of small writes and may increase speed of the write processing.

In addition, in the embodiment, the meta address management unit 24b manages pieces of information on meta addresses in each of which a logical address and an address of logical/physical meta are associated with each other, such that the logical/physical meta management unit 24a may specify a location of the logical/physical meta by using a meta address.

In addition, in the embodiment, when data has been updated, reference meta of a user data unit corresponding to old data is not updated. Thus, the storage control apparatus 2 may further reduce the number of small writes.

In addition, in the embodiment, meta addresses are managed in the main memory, and information on an overflowed meta address is stored at a specific location of the SSD 3d. Thus, the storage control apparatus 2 may obtain the information on the meta address by reading the information from the specific location of the SSD 3d.

In the embodiment, the storage control apparatus 2 is described above, and when the configuration included in the storage control apparatus 2 is realized by software, a storage control program including a function similar to the storage control apparatus 2 may be obtained. Thus, a hardware configuration of the storage control apparatus 2 that executes the storage control program is described below.

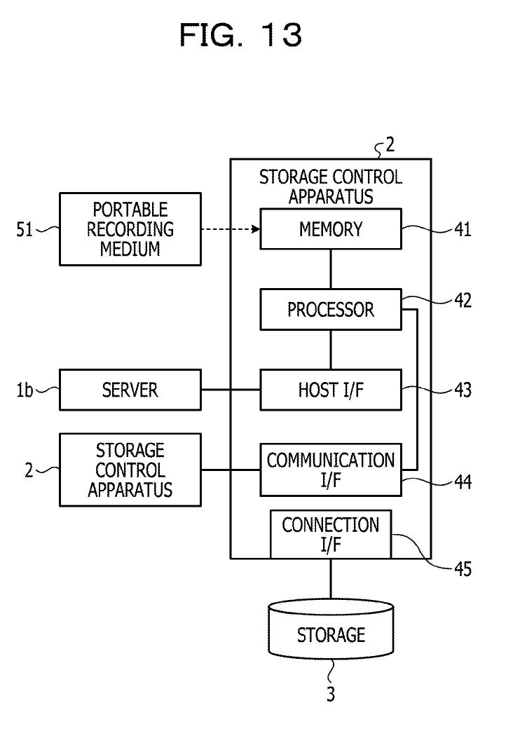

FIG. 13 is a diagram illustrating a hardware configuration of the storage control apparatus 2 that executes the storage control program according to the embodiment. As illustrated in FIG. 13, the storage control apparatus 2 includes a memory 41, a processor 42, a host I/F 43, a communication I/F 44, and a connection I/F 45.

The memory 41 is a random access memory (RAM) that stores a program and an execution intermediate result of the program. The processor 42 is a processing device that reads the program from the memory 41 and executes the program.

The host I/F 43 is an interface with the server 1b. The communication I/F 44 is an interface used to communicate with another storage control apparatus 2. The connection I/F 45 is an interface with the storage 3.

In addition, the storage control program to be executed in the processor 42 is stored in a portable recording medium 51 and read into the memory 41. Alternatively, the storage control program is stored in a database or the like of a computer system coupled through the communication interface 44, read from the database or the like, and read into the memory 41.

In addition, in the embodiment, the case is described in which the SSD 3d is used as a non-volatile storage medium, but the embodiment is not limited to such a case, and may also be applied to a case in which another non-volatile storage medium is used that includes a device characteristic similar to that of the SSD 3d.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control apparatus configured to control a storage device including a storage medium having a limit of a number of writes, comprising:
a memory; and
a processor coupled to the memory and configured to:
store, in the memory, address conversion information in which a logical address used to identify data by an information processing device using the storage device and a physical address indicating a memory location of the data in the storage medium are associated with each other, and
execute a bulk writing of a piece of the address conversion information into the storage medium sequentially.

2. The storage control apparatus according to claim 1, wherein
conversion location information in which a physical address indicating a location at which the bulk writing of the pieces of address conversion information stored in the memory into the storage medium sequentially as a meta address and the logical address are associated with each other is further stored in the memory.

3. The storage control apparatus according to claim 1, wherein
data stored at a physical address includes reference information indicating a logical address at which the data is referred to.

4. The storage control apparatus according to claim 3, wherein
the processor maintains the reference information in the storage medium with the data before update when new data is added due to the update of the data.

5. The storage control apparatus according to claim 2, wherein
the processor stores the meta address at a specific location of the storage medium.

6. The storage control apparatus according to claim 1, wherein
the storage medium is a solid state drive.

7. A storage control method configured to control a storage device including a storage medium having a limit of a number of writes, comprising:
storing address conversion information in which a logical address used to identify data by an information processing device using the storage device and a physical address indicating a memory location of the data in the storage medium are associated with each other; and
executing a bulk writing of a piece of the address conversion information into the storage medium sequentially.
